(19) United States
(12) Patent Application Publication
(10) Pub. No.: US 2016/0112802 A1
(43) Pub. Date: Apr. 21, 2016

(54) MICROPHONE AND METHOD OF MANUFACTURING THE SAME

(71) Applicant: Hyundai Motor Company, Seoul (KR)

(72) Inventor: Ilseon Yoo, Seoul (KR)

(21) Appl. No.: 14/852,577

(22) Filed: Sep. 13, 2015

(30) Foreign Application Priority Data
Oct. 17, 2014 (KR) 10-2014-0141157

(51) Int. Cl. H04R 7/10; H04R 19/00; H04R 31/00; H04R 19/04

(52) U.S. Cl. CPC H04R 7/10; H04R 19/04; H04R 19/005; H04R 31/00; H04R 2201/003

(57) ABSTRACT

A microphone and a method of manufacturing thereof are provided. The microphone includes a substrate that includes a penetration aperture, a vibration membrane disposed over the substrate and covering the penetration aperture, and a fixed electrode disposed over the vibration membrane and spaced apart from the vibration membrane and including a plurality of air inlets. The vibration membrane includes a first sub-vibration member disposed on the substrate and covering the penetration aperture, a second sub-vibration member disposed on the first sub-vibration membrane and including a plurality of slots, and a connection layer disposed between the first sub-vibration membrane and the second sub-vibration member and connecting the first sub-vibration membrane to the second sub-vibration membrane. The first sub-vibration membrane is flexible and the second sub-vibration membrane is rigid.

### CROSS-REFERENCE TO RELATED APPLICATION

This application claims priority to and the benefit of Korean Patent Application No. 10-2014-0141157 filed in the Korean Intellectual Property Office on Oct. 17, 2014, the entire contents of which are incorporated herein by reference.

### BACKGROUND

(a) Technical Field

The present invention relates to a microphone and a method of manufacturing the microphone.

(b) Description of the Related Art

Generally, a microphone converts a voice input into an electrical signal, and has been gradually downsized. Accordingly, a microphone using a microelectromechanical system (MEMS) technology is being developed. A MEMS microphone is advantageous since the MEMS microphone has increased resistant to humidity and heat compared to a conventional electret condenser microphone (ECM). Furthermore the MEMS microphone may be downsized and integrated with a signal processing circuit.

Typically, the MEMS microphone is divided into a capacitance MEMS microphone and a piezoelectric MEMS microphone. The capacitance MEMS microphone includes a fixed electrode and a vibration membrane. When the vibration membrane has an external sound pressure applied thereto, the distance between the fixed electrode and the vibration membrane changes thereby changing a capacitance value. The sound pressure is measured based on an electrical signal generated.

The piezoelectric MEMS microphone includes only a vibration membrane. When the vibration membrane is deformed by external sound pressure, an electrical signal is generated due to a piezoelectric effect. The sound pressure is measured based on the electrical signal. Significant research has been conducted to improve the sensitivity of the capacitance MEMS microphone.

The above information disclosed in this Background section is merely for enhancement of understanding of the background of the invention and therefore it may contain information that does not form the prior art that is already known in this country to a person of ordinary skill in the art.

### SUMMARY

The exemplary embodiment provides a microphone and a method of manufacturing for improving the sensitivity of the microphone, the signal-to-noise ratio (SNR), the frequency response range, and the maximum input sound pressure.

An exemplary embodiment provides a microphone that may include a substrate having a penetration aperture, a vibration membrane that may be disposed over the substrate and formed to cover the penetration aperture, and a fixed electrode that may be disposed over the vibration membrane and separated from the vibration membrane, including a plurality of air inlets. The vibration membrane may include a first sub-vibration member that may be disposed on the substrate and may cover the penetration aperture. A second sub-vibration member may be disposed on the first sub-vibration membrane and may include a plurality of slots. A connection layer may be disposed between the first sub-vibration membrane and the second sub-vibration member. The connection layer may connect the first sub-vibration membrane to the second sub-vibration membrane, wherein the first sub-vibration membrane may be flexible and the second sub-vibration membrane may be rigid.

The vibration membrane may include a vibration portion positioned over the penetration aperture and a fixed portion disposed over the substrate. The connection layer may be disposed over a portion of the first sub-vibration membrane within the vibration portion. The first sub-vibration membrane and the second sub-vibration membrane may be separated from each other by a predetermined interval at a region of the vibration portion except for a disposal region of the connection layer in the vibration portion.

Another aspect may include a support layer disposed over the fixed portion and positioned to support the fixed electrode. The first sub-vibration membrane and the second sub-vibration membrane may be made of polysilicon or conductive materials. The connection layer may be made of a metal, the fixed electrode may be made of polysilicon or a metal and the substrate may be made of silicon.

In another aspect a method of manufacturing a microphone may include preparing a substrate and forming a first sub-vibration membrane over the substrate and forming a first metal pattern layer on the first sub-vibration membrane. A carrier substrate may be prepared and a fixed electrode including a plurality of air inlets may be formed over the carrier substrate. A sacrificial layer may be formed over the fixed electrode; forming a second sub-vibration membrane that may include a plurality of slots disposed over the sacrificial layer. A second metal pattern layer may be formed on the second sub-vibration membrane. A connection layer may be formed by bonding the first metal pattern layer to the second metal pattern layer. The carrier substrate may be removed and a penetration aperture may be formed, a portion of the first sub-vibration membrane may be exposed by etching a rear of the substrate and the oxide layer and removing a portion of the sacrificial layer. The first sub-vibration membrane may be flexible and the second sub-vibration membrane may be rigid.

The carrier substrate may be disposed on the substrate during the formation of the connection layer. The first metal pattern may be bonded to the second metal pattern by performing eutectic bonding in the formation of the connection layer. The first metal pattern layer may be disposed at an edge portion and a substantially central portion of the first sub-vibration membrane. The second metal pattern layer may be disposed at an edge portion and a central portion of the second sub-vibration membrane.

As described above, according to an exemplary embodiment the vibration membrane may include the first sub-vibration membrane having flexibility and the second sub-vibration membrane. The sensitivity of the microphone may be improved, and the SNR, the frequency response range, and the maximum input sound pressure may be increased. Further, since the first sub-vibration membrane may be connected to the second sub-vibration membrane, the noise may be reduced.

### BRIEF DESCRIPTION OF THE DRAWINGS

FIG. 1 is an exemplary embodiment of a schematic cross-sectional view of a microphone in accordance with an exemplary embodiment of the present invention;

FIG. 2A is an exemplary embodiment of a graph illustrating the sensitivities of the microphone in accordance with an exemplary embodiment of the present invention and a conventional microphone;

FIG. 2B is an exemplary embodiment of a graph illustrating the sensitivities of the microphone in accordance with an exemplary embodiment and a conventional microphone;

FIG. 3 is an exemplary embodiment of a diagram illustrating a method of manufacture of the microphone in accordance with an exemplary embodiment of the present invention;

FIG. 4 is an exemplary embodiment of a diagram illustrating a method of manufacture of the microphone in accordance with an exemplary embodiment of the present invention;

FIG. 5 is an exemplary embodiment of a diagram illustrating a method of manufacture of the microphone in accordance with an exemplary embodiment of the present invention;

FIG. 6 is an exemplary embodiment of a diagram illustrating a method of manufacture of the microphone in accordance with an exemplary embodiment of the present invention;

FIG. 7 is an exemplary embodiment of a diagram illustrating a method of manufacture of the microphone in accordance with an exemplary embodiment of the present invention; and

FIG. 8 is an exemplary embodiment of a diagram illustrating a method of manufacture of the microphone in accordance with an exemplary embodiment of the present invention.

### DETAILED DESCRIPTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

Hereinafter, some exemplary embodiments of the present invention are described in detail with reference to the accompanying drawings. However, the present invention is not limited to the embodiments described herein, and may be materialized in other forms. On the contrary, the introduced embodiments are provided to make disclosed contents thorough and complete and to sufficiently deliver the spirit of the present invention to those skilled in the art. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, In order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In the drawings, the thickness of layers and areas has been enlarged for clarity of description. Furthermore, when it is said that a layer is “on” another layer or substrate, the layer may be directly formed on another layer or substrate or a third layer may be interposed therebetween.

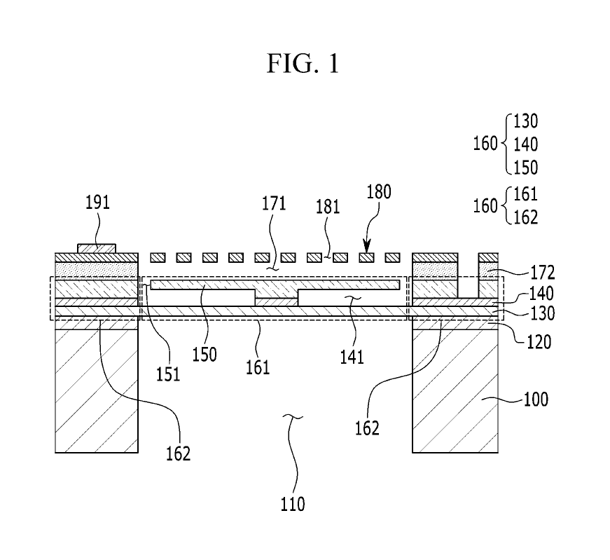

Hereinafter, a microphone in accordance with an exemplary embodiment of the present invention is described with reference to FIG. 1. FIG. 1 is an exemplary embodiment of a schematic cross-sectional view of a microphone. Referring to FIG. 1, the microphone may include a substrate 100, a vibration membrane 160, and a fixed electrode 180. The substrate 100 may be made of silicon, and a penetration aperture 110 may be formed within the substrate 100. The vibration membrane 160 may be disposed on the substrate 100. The vibration membrane 160 may cover the penetration aperture 110.

An oxide layer 120 may be disposed between the substrate 100 and the vibration membrane 160. The vibration membrane 160 may include a vibration portion 161 and a fixed portion 162. The vibration portion 161 may cover the penetration aperture 110, and the fixed portion 162 may be disposed therein along with the oxide layer 120. The vibration portion 161 may be exposed through the penetration aperture 110, and the vibration portion 161 may vibrate in response to external sound.

Further, the vibration membrane 160 may include a first sub-vibration membrane 130, a second sub-vibration membrane 150, and a connection layer 140 that may connect the first sub-vibration membrane 130 to the second sub-vibration membrane 150. The first sub-vibration membrane 130 may be disposed on the oxide layer 120, and may cover the penetration aperture 110. The first sub-vibration membrane 130 may be flexible. The connection layer 140 may include a metal material, and may be disposed on the first sub-vibration membrane 130. The second sub-vibration membrane 150 may be disposed on the connection layer 140, and may include a plurality of slots 151. The second sub-vibration membrane 150 may have a rigid structure. Further, the second sub-vibration membrane 150 within the vibration portion 161 may include a protrusion that may contact the connection layer 140.

The first sub-vibration membrane 130 and the second sub-vibration membrane 150 may be made of polysilicon. Additionally, the materials of the first sub-vibration membrane 130 and the second sub-vibration membrane 150 may not be limited to the polysilicon material. For example, the first sub-vibration membrane 130 and the second sub-vibration membrane 150 may be made of conductive materials.

The connection layer 140 may be disposed between the first sub-vibration membrane 130 and the second sub-vibration membrane 150, and may physically connect the first sub-vibration membrane 130 to the second sub-vibration membrane 150. Furthermore, since the connection layer 140 may be made of a metal material, the connection layer 140 may electrically connect the first sub-vibration membrane 130 to the second sub-vibration membrane 150. The connection layer 140 may be disposed between the vibration portion 161 and the fixed portion 162. The connection layer 140 that may be formed within the vibration portion 161 may be disposed at a portion of the first sub-vibration membrane 130, and may contact the protrusion of the second sub-vibration membrane 150.

Additionally, a first air layer 141 may be formed between the first sub-vibration membrane 130 and the second sub-vibration membrane 150 within the vibration portion 161. For example, the first sub-vibration membrane 130 and the second sub-vibration membrane 150 may be separated from each other at a predetermined interval at a region of the vibration portion 161 except for a disposal region of the connection layer 140 within the vibration portion 161. Further, the connection layer 140 may be disposed at the fixed portion 162 to serve as a pad to transfer changed capacitance to be described later to a signal processing circuit (not shown).

The fixed electrode 180 separated from the vibration membrane 160 may be disposed on the vibration membrane 160. The fixed electrode 180 may be disposed over a support layer 172 and fixed thereto. The support layer 172 may be disposed at a portion of the edge of the sub-vibration membrane 150, and may support the fixed electrode 180. In some exemplary embodiments, the fixed electrode 180 may be made of polysilicon or a metal.

A second air layer 171 may be formed between the fixed electrode 180 and the second sub-vibration membrane 150. The fixed electrode 180 and the second sub-vibration membrane 150 may be separated from each other by a predetermined interval. Additionally, a plurality of air inlets 181 may be disposed in the fixed electrode 180. An external sound may be introduced through the air inlets 181 formed in the fixed electrode 180, thereby stimulating the vibration membrane 160. In response to the stimulation, the vibration membrane 160 may vibrate.

For example, the external sound introduced through the air inlets 181 may stimulate the first sub-vibration membrane 130 through the slots 151 of the second sub-vibration membrane 150. Further, the flexible first sub-vibration membrane 130 may vibrate. For example, when the first sub-vibration membrane 130 vibrates, the second sub-vibration membrane 150 connected to the first sub-vibration membrane 130 may also vibrate. Further, when a sound is introduced through the penetration aperture 110, the sound may directly stimulate the first sub-vibration membrane 130.

When the vibration membrane 160 vibrates in response to the external sound, the distance between the second sub-vibration membrane 150 and the fixed electrode 180 may change. Accordingly, capacitance between the second sub-vibration membrane 150 and the fixed electrode 180 may change. A signal processing circuit (not shown) may convert the changed capacitance into an electrical signal through a pad 191 connected to the fixed electrode 180 and the connection layer 140 disposed at a fixed portion 162 of the vibration membrane 160, to thus detect the external sound.

Typically, a conventional microphone has a structure with one flexible vibration membrane. When a vibration membrane vibrates, the distance between the fixed electrode and the vibration membrane may vary. However, the microphone according to the present exemplary embodiment has a structure in which the vibration membrane 160 may include a flexible first sub-vibration membrane 130 and a rigid second sub-vibration membrane 150. The first sub-vibration membrane 130 may be connected to the second sub-vibration membrane 150, when the first sub-vibration membrane 130 vibrates, the second sub-vibration membrane 150 may be displaced in the vertical and lateral directions. Further, the rigidity of the second sub-vibration membrane 150 may maintain the uniform distance between the fixed electrode 180 and the second sub-vibration membrane 150. Additionally, the sensitivity of the microphone may be improved, and the SRN a frequency response range, and the maximum input sound pressure may be increased.

Moreover, a package type of the microphone may include a top port type where an aperture may be disposed at a top portion and a bottom port type where an aperture may be disposed at a bottom portion. An SNR of the bottom port type of microphone where sound pressure is directly transferred to the vibration membrane may provide improved performance compared to that of the top port type of microphone. In the present exemplary embodiment, the first sub-vibration membrane 130 having flexibility may be disposed under the second sub-vibration membrane 150. The microphone may be packaged as the bottom port type, the external sound pressure may pass through the penetration aperture 110 and may be directly transferred to the first vibration membrane 130, and therefore loss of sound pressure may be minimized Additionally, the performance of the microphone may be improved. Further, the first sub-vibration membrane 130 may be connected to the second sub-vibration membrane 150, and the microphone may provide an effect to reduce generation of noise.

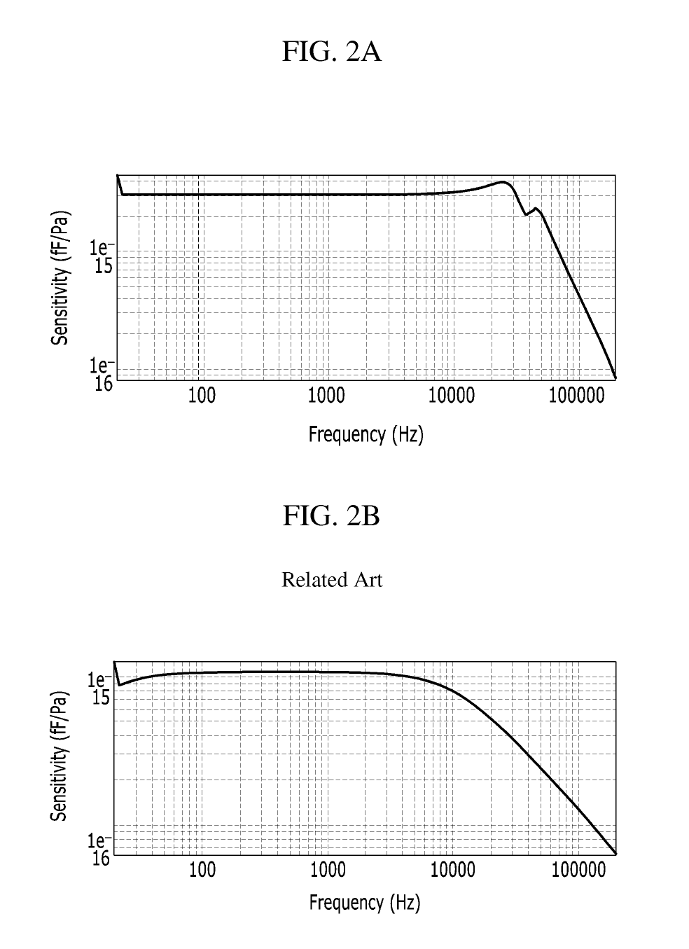

The sensitivity characteristics of the microphone in accordance with an exemplary embodiment and a conventional microphone are described below with reference to FIGS. 2A and 2B. FIG. 2A is an exemplary embodiment of a graph illustrating the sensitivity of the microphone in accordance with an exemplary embodiment of the present invention, and FIG. 2B is an exemplary embodiment of a graph illustrating the sensitivity of the conventional microphone.

In FIGS. 2A and 2B, the vibration membrane of the microphone according to an exemplary embodiment has a structure that may include the first sub-vibration membrane, the connection layer, and the second sub-vibration membrane. A vibration membrane of the conventional microphone has a structure including one vibration membrane. For example, the first sub-vibration membrane and the second sub-vibration membrane of the microphone according to the present exemplary embodiment and the vibration membrane of the conventional microphone may be made of polysilicon. FIGS. 2A and 2B illustrate that the microphone according to the exemplary embodiment has sensitivity (fF/Pa) of about 3 at 1 KHz and the conventional microphone has sensitivity (fF/Pa) of about 1 at 1 KHz. For example, the sensitivity of the microphone according to the exemplary embodiment may be about 3 times that of the conventional microphone.

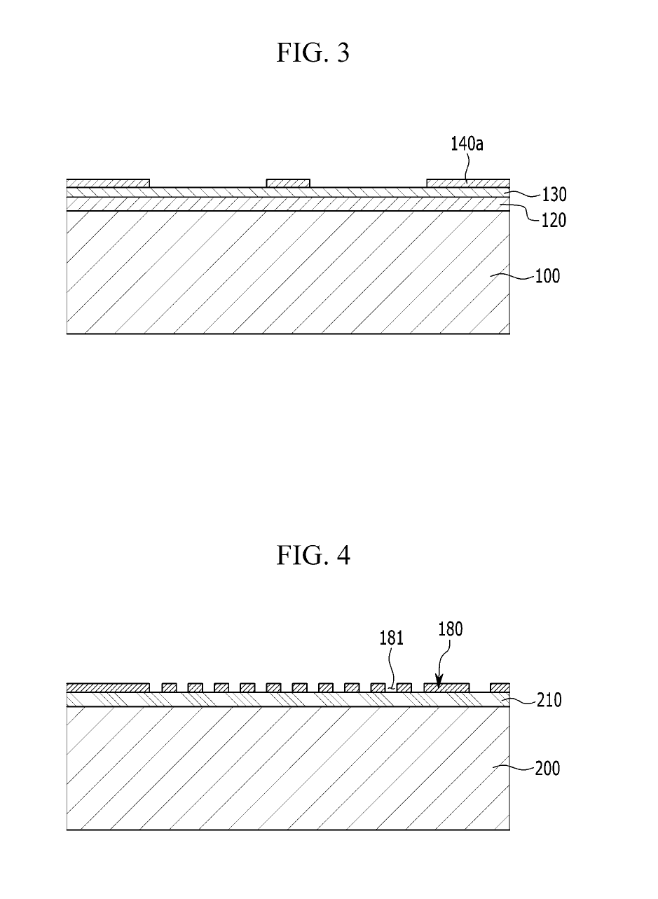

A method of manufacturing the microphone in accordance with an exemplary embodiment is described below with reference to FIGS. 1 and 3 to 8. FIGS. 3 to 8 are exemplary diagrams illustrating a method of manufacturing the microphone in accordance with an exemplary embodiment of the present invention. Referring to FIG. 3, after the substrate 100 is prepared, the oxide layer 120 may be formed on the substrate 100. The first sub-vibration membrane 130 may be formed on the oxide layer 120. In particular, the substrate 100 may be made of silicon, and the first sub-vibration membrane 130 may be made of polysilicon or conductive materials. Further, the first sub-vibration membrane 130 may be flexible. Additionally, a first metal pattern layer 140a may be formed on the first sub-vibration membrane 130. The first metal pattern layer 140a may be disposed at an edge portion and a substantially central portion of the first sub-vibration membrane 130.

Referring to FIG. 4, after a carrier substrate 200 is prepared, a buffer layer 210 may be formed on the carrier substrate 200. The fixed electrode 180 including the plurality of air inlets 181 may be formed on the buffer layer 210. Particularly, the carrier substrate 200 may be made of silicon, and the fixed electrode 180 may be made of polysilicon or a metal. The fixed electrode 180 including the plurality of air inlets 181 may be formed by forming a polysilicon layer or a conductive material layer on the buffer layer 210 and patterning the polysilicon layer or the metal layer. The patterning of the polysilicon layer or the metal layer may be performed by forming a photoresist layer on the polysilicon layer or the metal layer, forming a photoresist layer pattern by performing exposure and development on the photoresist layer, and etching the polysilicon layer or the metal layer using the photoresist layer pattern as a mask.

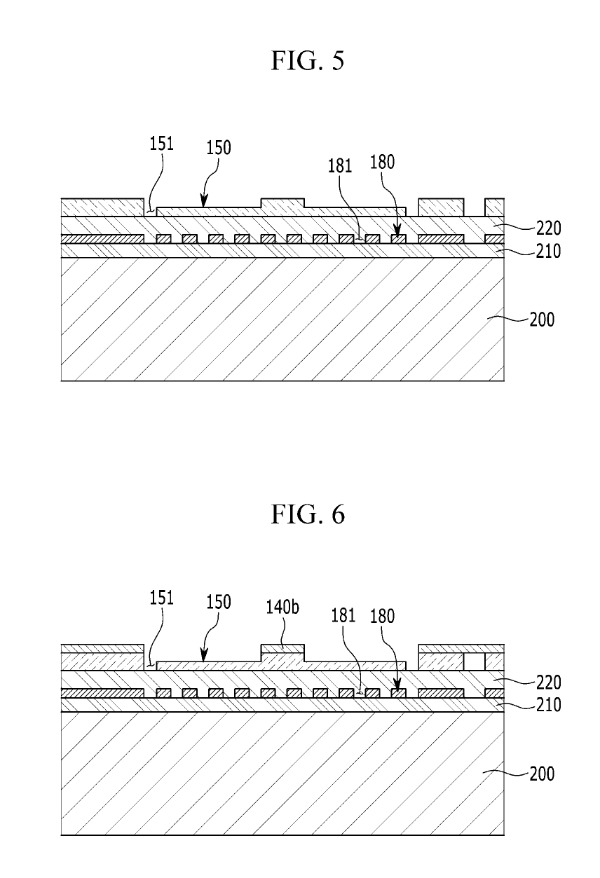

Referring to FIG. 5, after a sacrificial layer 220 is formed on the fixed electrode 180, the second sub-vibration membrane 150 including the plurality of slots 151 may be formed on the sacrificial layer 220. The sacrificial layer 220 may be made of photoresist materials, a silicon oxide, or a silicon nitride. The second sub-vibration membrane 150 may be made of polysilicon or conductive materials. Additionally, the second sub-vibration membrane 150 may be rigid. and may be formed by forming a polysilicon layer or a conductive material layer on the sacrificial layer 220, and patterning the polysilicon layer or the conductive material layer. In particular, the patterning of the polysilicon layer or the conductive material layer may be performed by forming a photoresist layer on the polysilicon layer or conductive material layer, forming a photoresist layer pattern by performing exposure and development on the photoresist layer, and etching the polysilicon layer or conductive material layer using the photoresist layer pattern as a mask. For example, a protrusion making contact with a second metal pattern layer 140b to be described below may be formed at the second sub-vibration membrane 150.

Referring to FIG. 6, a second metal pattern layer 140b may be formed on the second sub-vibration membrane 150. The second metal pattern layer 140b may be disposed on the protrusion disposed at the edge portion and the central portion of the second sub-vibration membrane 150.

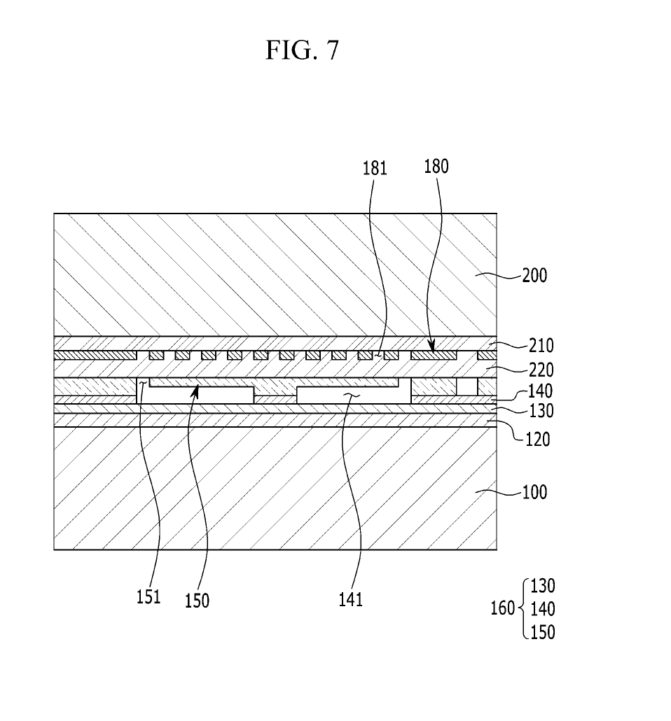

Referring to FIG. 7, the connection layer 140 may be formed by bonding the first metal pattern layer 140a to the second metal pattern layer 140b. Additionally, the vibration membrane 160 may be formed therein with the first sub-vibration membrane 130, the second sub-vibration membrane 150, and a connection layer 140 to connect the first sub-vibration membrane 130 to the second sub-vibration membrane 150. Namely, the first metal pattern layer 140a may be bonded to the second metal pattern layer 140b by performing eutectic bonding. When the first metal pattern layer 140a is bonded to the second metal pattern layer 140b, the carrier substrate 20 may be disposed at an upper portion of the substrate 100. A first air layer 141 may be formed between the first sub-vibration membrane 130 and the second sub-vibration membrane 150. In other words, the first sub-vibration membrane 130 and the second sub-vibration membrane 150 may be spaced apart from each other at a predetermined interval at a region except for a disposal region of the connection layer 140.

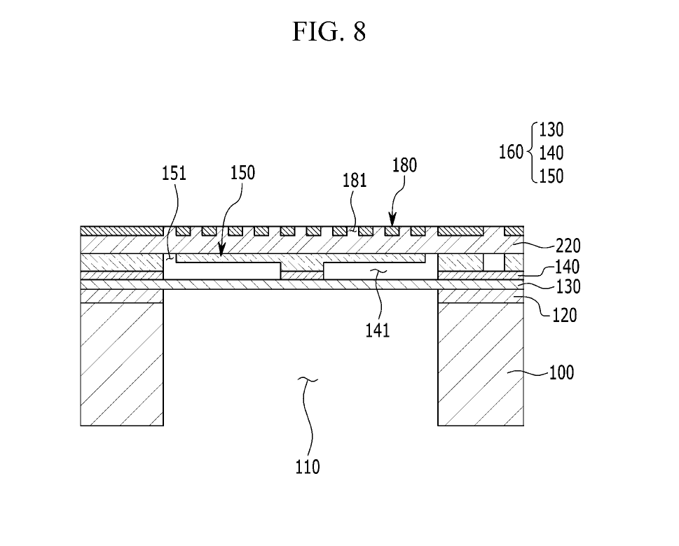

Referring to FIG. 8, the carrier substrate 200 and the buffer layer 210 may be removed, and a penetration aperture 110 may be formed in the substrate 10. The penetration aperture 110 may be formed by performing dry etching or wet etching on the rear of the substrate 100. When the rear of the substrate 100 is etched, the oxide layer 120 may be partially etched to expose a portion of the first sub-vibration membrane 130.

Referring to FIG. 1, the second air layer 171 and the support layer 172 may be formed by removing a portion of the sacrificial layer 220. For example, the vibration membrane 160 may include a vibration portion 161 and a fixed portion 162. The fixed portion 162 may be disposed between the oxide layer 120 and the support layer 172, and the vibration portion 161 may be disposed between the penetration aperture 110 and the second air layer 171.

The sacrificial layer 162 may be removed by a wet method using an etchant through the air inlets 181. Furthermore, the sacrificial layer 162 may be removed using a dry method, such as ashing according to oxygen (O₂) plasma, through the air inlets 181. Part of the sacrificial layer 220 may be removed through a wet or dry method, and thus the second air layer 171 may be formed between the fixed electrode 180 and the second sub-vibration membrane 150. The sacrificial layer 220 that remains intact without being removed may form the support layer 172 that supports the fixed electrode 180. The support layer 172 may be formed on the second sub-vibration membrane 150 of the fixed part 162.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the appended claims. In addition, it is to be considered that all of these modifications and alterations fall within the scope of the present invention.

### DESCRIPTION OF SYMBOLS

100: substrate

110: penetration aperture

130: first sub-vibration membrane

140: connection layer

140a, 140b: first and second metal pattern layers

141: first air layer

150: second sub-vibration membrane

151: slot

160: vibration membrane

161: vibration portion

162: fixed portion

171: second air layer

172: support layer

180: fixed electrode

181: air inlet

191: pad

200: carrier substrate

220: sacrificial layer

What is claimed is:

1. A microphone, comprising:
a substrate having a penetration aperture;
a vibration membrane disposed over the substrate and covering the penetration aperture; and
a fixed electrode disposed over the vibration membrane and separated from the vibration membrane having a plurality of air inlets,
wherein the vibration membrane comprises:
a first sub-vibration member disposed on the substrate and covering the penetration aperture;
a second sub-vibration member disposed on the first sub-vibration membrane and having a plurality of slots; and
a connection layer disposed between the first sub-vibration membrane and the second sub-vibration member connecting the first sub-vibration membrane to the second sub-vibration membrane,
wherein the first sub-vibration membrane is flexible and the second sub-vibration membrane is rigid.

2. The microphone of claim 1, wherein the vibration membrane includes a vibration portion disposed over the penetration aperture and a fixed portion disposed over the substrate.

3. The microphone of claim 2, wherein the connection layer is disposed over a portion of the first sub-vibration membrane within the vibration portion.

4. The microphone of claim 3, wherein the first sub-vibration membrane and the second sub-vibration membrane are separated from each other by a predetermined interval at a region of the vibration portion except for a disposal region of the connection layer in the vibration portion.

5. The microphone of claim 2, further comprising:
a support layer disposed over the fixed portion and positioned to support the fixed electrode.

6. The microphone of claim 1, wherein the first sub-vibration membrane and the second sub-vibration membrane are made of a polysilicon or conductive materials.

7. The microphone of claim 6, wherein the connection layer is made of a metal material.

8. The microphone of claim 7, wherein the fixed electrode is made of a polysilicon or a metal material.

9. The microphone of claim 8, wherein the substrate is made of a silicon.

10. A method of manufacturing a microphone, comprising:
preparing a substrate and forming a first sub-vibration membrane over the substrate;
forming a first metal pattern layer on the first sub-vibration membrane;
preparing a carrier substrate and forming a fixed electrode, having a plurality of air inlets over the carrier substrate;
forming a sacrificial layer over the fixed electrode;
forming a second sub-vibration membrane having a plurality of slots over the sacrificial layer;
forming a second metal pattern layer on the second sub-vibration membrane;
forming a connection layer by bonding the first metal pattern layer to the second metal pattern layer;
removing the carrier substrate and forming a penetration aperture through which part of the first sub-vibration membrane is exposed by etching a rear of the substrate and the oxide layer; and
removing part of the sacrificial layer,
wherein the first sub-vibration membrane is flexible and the second sub-vibration membrane is rigid.

11. The method of claim 10, wherein the carrier substrate is disposed on the substrate in the forming of the connection layer.

12. The method of claim 11, wherein the first metal pattern is bonded to the second metal pattern by performing eutectic bonding in the forming of the connection layer.

13. The method of claim 12, wherein the first metal pattern layer is disposed at an edge portion and a central portion of the first sub-vibration membrane.

14. The method of claim 13, wherein the second metal pattern layer is disposed at an edge portion and a central portion of the second sub-vibration membrane.

15. The method of claim 10, wherein the first sub-vibration membrane and the second sub-vibration membrane are made of a polysilicon or conductive materials.

16. The method of claim 15, wherein the fixed electrode is made of a polysilicon or a metal.

17. The method of claim 10, wherein the substrate and the carrier substrate comprise silicon.
